(19) United States
(12) Patent Application Publication
(10) Pub. No.: US 2010/0169232 A1
(43) Pub. Date: Jul. 1, 2010

(54) Arrangement and Method for Fundraising and a Server

(76) Inventor: Anders Wikström, Itasalmi (FI)

Correspondence Address: POTOMAC PATENT GROUP PLLC, P. O. BOX 270, FREDERICKSBURG, VA, 22404, US

(21) Appl. No.: 11/883,261

(22) PCT Filed: Jan. 27, 2006
(86) PCT No.: PCT/FI06/50045

§ 371 Date: Mar. 10, 2009

(30) Foreign Application Priority Data
Jan. 27, 2005 (FI) 20050088

(51) Int. Cl. G06Q 99/00; G06F 15/16; G06Q 40/00; G06T 11/00

(52) U.S. Cl. 705/329; 709/206; 345/467

(57) ABSTRACT

The invention relates to an arrangement and a method for fundraising and a server that makes this possible. In the invention, an arrangement for fundraising is presented, which arrangement comprises a user, a teleoperator, an Internet-type network, a database and a data communications network operating between the user and the teleoperator such, that the arrangement additionally comprises a fundraising system, that receives donations made by the user to a virtual objective, and which fundraising system comprises a server for receiving donations and messages and additionally means to deliver and present to the user real-time information relating to the virtual objective.

The invention relates to an arrangement and a method for fundraising and a server that makes this possible. More specifically, it concerns an arrangement and a method as well as a server, using which procurement of funds occurring around the world in the network for various relief objectives is possible.

Participating in different fundraising campaigns and collections is extremely important to many persons around the world. Usually, this kind of fundraising takes place through different organizations and as different events or approaches by people they have arranged.

Already for many years these types of different fundraising events have been organized by the Red Cross, the Salvation Army and the Finnish Missionary Society. Fundraising has in practice occurred, for example, as campaigns, wherein funds have been collected from persons in collection boxes and different money containers as well as by asking people to participate in relief by directly putting money as a bank transfer into the account of organizations, etc.

Fundraising operations have generally in practice required the participation of a great many people in them as well as a great deal of practical arrangements, but also a great deal of activism on the part of a great many people in order that as many possible donors of money can in practice be reached and be gotten to give the money donation in question.

The problem with the different fundraising means mentioned above has also been that the givers of donations are in many cases the same persons that have also participated in collections in the past and are old acquaintances of organizations. These persons are known in the personal name lists of organizations as possible volunteer donators of funds and supporting members.

In practice, this means that these organizations raising funds for different relief objectives leave large sums of funds uncollected from those people who would possibly be very interested in donating money, but who are never reached during the time of the collection or the information is just never gotten to them that the collection is even taking place. Additionally, very many potential donors may view the current fundraising system as inconvenient and difficult and for these reasons do not use them.

Additionally, it is a severe problem in current fundraising systems that people who have made donations do not see anything concrete of what the donation they have made makes to the donation objective in question and often the donation objective itself remains completely unknown. Many donors have no idea where they have put their money and may even feel that they have been cheated. Many a donor would like to see something concrete that has been achieved due to the donation he has given.

Relating to fundraising different methods and systems have become known in the art.

The fundraising system and method that is the object of this invention deviates from earlier solutions developed for this purpose. A method and system according to the invention and a server and data terminals relating to the system concentrate on solving different problems than solutions presented by prior known art. In the invention, a fundraising process is described from different points of departure.

A growing need has been born for this type of service that approaches the different sectors relating to fundraising as one whole and attempts to facilitate and increase the efficiency of the actions occurring in their environment using new technology.

The object of the invention is to facilitate the fundraising process such, that it would be as easy as possible for people to give their desired donation as well as to actively and accurately monitor their virtual relief objective, i.e. how the donation they have given has helped and developed the relief objective in practice.

The invention allows a new type of possibility for monitoring the concrete effects that a donation that has been given has on the virtual relief objective in question. Additionally, the object of the invention is to achieve a large increase in the number of donating persons, i.e. to get many new donors into the group of donating persons.

The invention presented in this application, which relates to an arrangement and a method for fundraising as well as a server related to this, describes an arrangement that is essentially different from arrangements of known art.

A solution according to the invention also attempts from the point of departure to solve problems that deviate from those of prior known publications.

The invention is described in more detail in the accompanying claims. According to the invention is provided an arrangement for fundraising, which arrangement comprises:

a user, a teleoperator, an Internet-type network, a database and a data communications network operating between the user and the teleoperator such, that the arrangement additionally comprises a fundraising system that receives donations made by the user to a virtual objective, and which fundraising system comprises:

a server for receiving donations and messages, means to deliver and present to the user real-time information relating to the virtual objective.

Preferably, the arrangement comprises an electronic mail server for receiving and sending of electronic mail messages.

Preferably, the connection between the user and the server occurs via an electronic mail server.

Preferably, the arrangement comprises means for registering donations and messages in the server.

Preferably, the arrangement comprises means for storing the received messages in the database.

Preferably, the arrangement comprises means to deliver and graphically present concretely to the user a virtual picture/village view of the development of the virtual relief objective.

Preferably, in the arrangement, the database is integrated into the system.

Preferably, in the arrangement, the database is integrated into the server.

Preferably, in the arrangement, the user is in connection by electronic mail, with the electronic mail server using a data terminal.

Alternatively, in the arrangement, the user is in an Internet-type connection with the server using a data terminal.

Alternatively, the user is connected to the server using a mobile data terminal via a data communications network operating between the user and the teleoperator.

Preferably, in the arrangement, the user defines to the server the manner in which he wishes to give his donation.

Preferably, in the arrangement, the user can make a donation by text message, credit card, network bank or other digital means of payment.

Preferably, in the arrangement, the user stores in the database the information the user has given about himself.

Preferably, in the arrangement, the information provided by the user includes i.a. name, address, age, telephone number and electronic mail address information.

Preferably, in the arrangement, the virtual relief objectives selected by the user are villages/cities and their related different virtual donation objectives around the world.

Preferably, in the arrangement, the user adopts the virtual relief objective or virtual donation objective he has selected.

Preferably, in the arrangement, the user selects whether he wishes to challenge other contributors to participate by clicking the “challenge” menu on the screen and entering on the screen the electronic mail addresses or identification codes of the persons to be challenged.

Preferably, in the arrangement, the information relating to the virtual relief objective delivered and presented by the server to the user are news about the relief objective, general information about the village, commentator from a village inhabitant, development indicators from the relief objective and a graphic virtual village view of the development of the relief objective.

According to the second feature of the invention, a method for fundraising is provided, which method comprises a user, a teleoperator, an Internet-type network, a database and a data communications network operating between the user and the teleoperator such, that the arrangement additionally comprises a fundraising system such, that in the method the fundraising system receives donations made by the user to a virtual objective and such, that the fundraising system delivers and presents to the user real-time information relating to the virtual objective.

Preferably, in the method, the user first connects to the server.

Preferably, in the method, the user registers/logs in to a service on the server.

Preferably, in the method, the user opens in the service the link of the desired virtual relief objective, wherein the information about the village window from the virtual relief objective opens on the screen.

Preferably, in the method, the user receives information about the virtual relief objective and its development by clicking the desired virtual relief objective in the village view.

Preferably, in the method, the user makes a donation either to the virtual relief objective already started by clicking the virtual relief objective in question in the village view, or alternatively to a new virtual relief objective, which is selected from the building menu, and having selected the relief objective the user pushes the donate-button from the object window opening on the screen.

Preferably, in the method, the user selects the manner of donation, which are text message, network bank, credit card and other digital means of payment.

Preferably, in the method, the user selects whether he will adopt the virtual relief objective.

Preferably, in the method, the user selects whether he wishes to challenge other contributors to participate by clicking the “challenge” menu on the screen and entering on the screen the electronic mail addresses or identification codes of the persons to be challenged.

According to the third feature of the invention, a server for fundraising is provided in an arrangement, which comprises a user, a teleoperator, an Internet-type network, a database and a data communications network operating between the user and the teleoperator such, that the server comprises means for receiving donations and messages to the server as well as means to deliver and present to the user real-time information relating to the virtual objective.

Preferably, in the arrangement, the database is integrated into the server.

Preferably, in the arrangement, the user is in an Internet-type connection with the server using a data terminal.

Alternatively, in the arrangement, the user is connected to the server using a mobile data terminal via a data communications network operating between the user and the teleoperator.

Preferably, the arrangement comprises means for receiving and sending electronic mail messages via an electronic mail server.

Preferably, the arrangement comprises means for registering donations and messages in the server.

Preferably, the arrangement comprises means for storing received messages in the database.

Preferably, the arrangement comprises means to deliver and present concretely to the user a graphic virtual picture/village view of the development of the virtual relief objective.

In the following the invention is described in more detail with reference to the figures of this application.

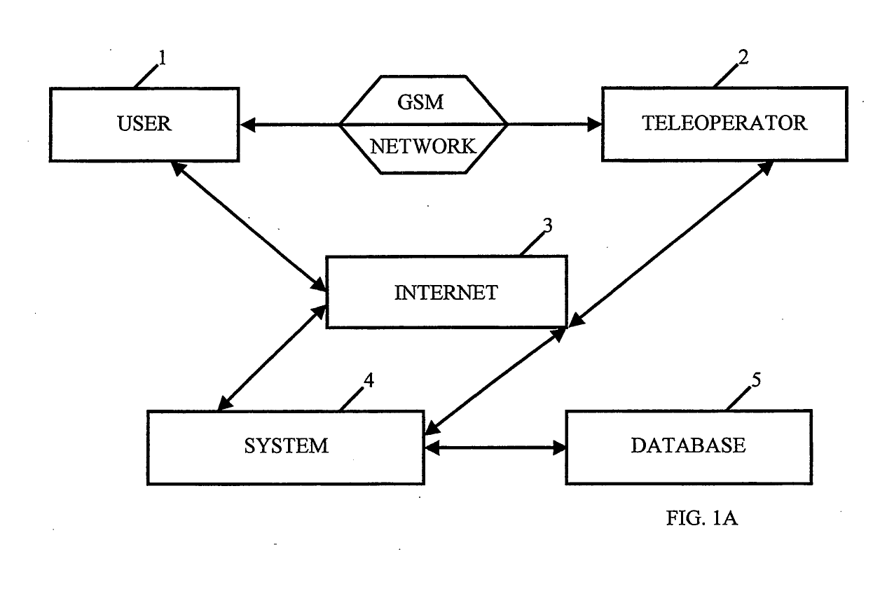

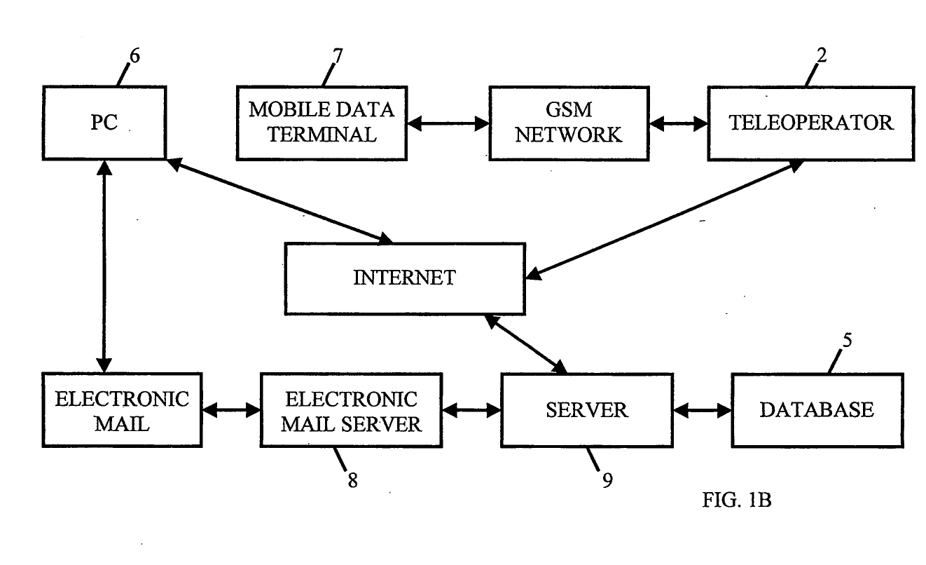

FIG. 1A shows an arrangement according to the invention in its entirety as a diagrammatic drawing.

FIG. 1B shows an arrangement according to the invention in more detail as a diagrammatic drawing.

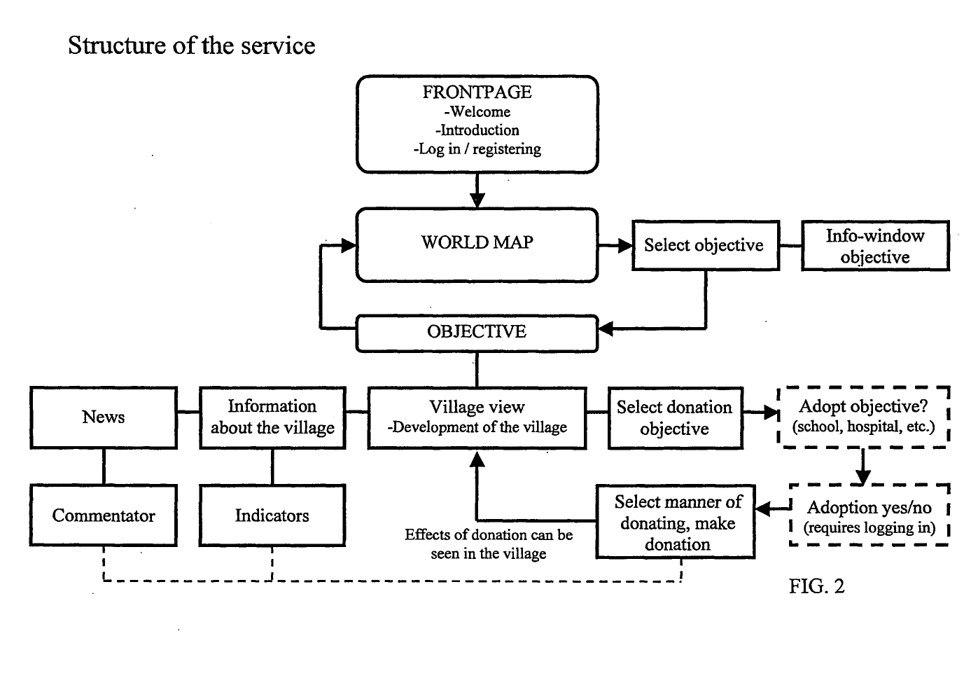

FIG. 2 shows the function of an arrangement and service according to the invention in more detail as a diagrammatic drawing.

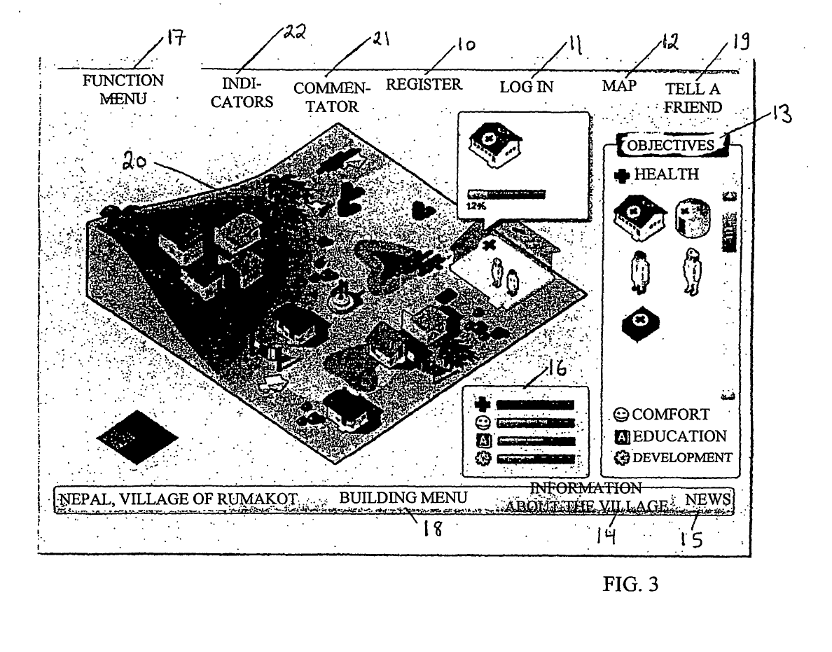

FIG. 3 shows a virtual relief objective according to the invention.

The invention presents an arrangement and a method that is built around a database and a server intended for fundraising. This whole arrangement and service entity functions in an Internet and mobile environment.

FIG. 1A shows an arrangement according to the invention as a diagrammatic drawing. The figure shows an arrangement and method for fundraising.

FIG. 1A shows a contributor 1 according to the invention, a teleoperator 2, a data communications network operating between these, an Internet-type network 3, a system 4 and a database 5 that is either outside of the system or alternatively belonging to the inside and functioning in connection with the system.

In the arrangement and method in question, an Internet-type network and computer-assisted data management are used, with which contributions can be gathered around the world from anyone whosoever. This concerns a service for procurement of funds occurring in a network.

In the service, contributors/users build virtual relief objectives depicting real relief objectives, such as a virtual village. The service contains all relief objectives in use all over the world. Virtual donation objectives, to which the contributors give their money, are i.a. hospitals, schools, wells, vaccinations, water pipe networks, etc. within the virtual village.

In the system, the donor builds and develops the virtual relief objective, for example, a village, with his donations and can see from his computer how the donations concretely help and build and develop the virtual village. The aid which contributors give is done easily and quickly by text message, network bank, credit card or other digital means of payment such as, for example, using pre-paid codes. Donations may be given in any sum whatsoever.

The contributor sees the development of the virtual village and objective he is aiding from the graphic indicators and percentages describing development degrees in different virtual relief objectives. When a contributor makes a donation to some donation objective, he sees immediately its arrival to the destination as an animation and as development of the objective in the virtual village. The purpose of the system and the method is to visually make concrete to the donor relief goals, needs, objectives and influence on relief objective.

In the system and the method, the virtual relief objectives and donation objectives in question are linked to real relief objectives and relief areas as well as to real needs. The system and the method provide information and statistics about the objective areas, objectives, relief needs and ongoing projects in the relief objective. A contributor can additionally join an electronic mail list, from which he will receive additional information relating to the service.

The relief system is intended for all persons, enterprises as well as communities. Registered contributors and users can if they wish found donor groups in the system and invite along friends, relatives, co-workers etc.

The object of the invention is to remove the impracticality, difficulty and inefficiency ruling current markets that is related to procurement of funds as well as to persuade along new contributors. Additionally, using the system and method, the intension is to give more and better information concretely to the contributors relating to relief objectives, in order that contributors would better know where they are investing their money.

FIG. 1B shows an arrangement according to the invention in somewhat more detail as a diagrammatic drawing. FIG. 1B shows in more detail the system and method for fundraising.

FIG. 1B comprises a data terminal according to the invention (PC) 6, a mobile data terminal 7, an electronic mail server 8 and a server 9. The system 4 contains within it an electronic mail server 8, a server 9 and if desired also a database 5. The database 5 can also be a separate unit outside of the system 4.

In a relief arrangement according to the invention, the user 1 is in connection with the system 4 either by electronic mail, through the Internet, or alternatively using a teleoperator 2. The connection between the user 1 and the system 4 occurs via an electronic mail server 8. The connection using the Internet 3 occurs by utilizing an Internet-type network with a www-browser and using a data terminal 6.

The connection between the user 1 and the system 4 using the teleoperator 2 occurs in a gsm network using a mobile data terminal 7. The user 1 makes a connection on his data terminal 7 in the gsm network to the teleoperator 2, who in turn connects to the system 4 using the Internet 3 and sends the relief message of the user 1 forward to the system 4. The system 4 sends messages back to the user 1 in exactly the manner described above. The system 4 contains within it an electronic mail server 8 as well as a server 9 and if desired also a database 5.

In the system, the server 9 handles receipt of relief messages as well as sending of all messages and the database 5 for its part stores in the system all information coming to it.

FIG. 2 shows an arrangement and service according to the invention in more detail as a diagrammatic drawing.

FIG. 2 comprises the following operations according to the invention:

Initially, the user 1 of the service makes a connection to the server 9 by electronic mail, using the Internet 3 or using a mobile data terminal 7. The making of a connection by electronic mail is mainly for writing messages and receiving messages from the server 9. Use of the portable data terminal 7 is for paying for donations as well as for receiving messages.

When the user 1 of the service makes a connection to the server 9 using the Internet 3, the user 1 ends up at the front page of the fundraising service contained in the server 9.

Initially, the user 1 is welcomed to the service and the service is introduced, this idea being collection of funds from contributors using text message, network bank, credit card or other digital means of payment such as, for example, using pre-paid codes, as well as to visually make concrete relief goals, needs, objectives and influence on relief objectives. The provider of the service is in practice responsible for getting the relief to its destination.

Next, the user 1 registers/logs in to the service. The service can also be used without registering and without logging in, except for services that are directed toward those who are registered. A registered user can if desired receive by electronic mail messages about the development, needs and news etc. of a selected relief objective. A registered user can also found a donor group and challenge other donors to participate in giving relief. During registration the user 1 is asked for information such as i.a. name, age, postal address, electronic mail address, desired user identification, password etc. The one-time donation sum of those less than 18 years of age is limited.

Next, the user 1 sees a map of the world, on which all currently existing relief objectives can be seen with numbers.

As the user 1 opens the link of the relief objective he desires, additional information, an info-window, opens on the map about the relief objective such as number of inhabitants, religions, means of livelihood and relief needs etc. The objectives themselves are presented graphically on the screen such that they outwardly resemble, for example, the real village including its buildings.

In the graphic game view of the relief objective, the user 1 receives information about the village that is the relief objective and its development. The menus providing this information are village view, information about the village, upper menu/news, commentators and indicators.

The user 1 receives information about the relief objective and its development by clicking the objective he desires in the village view, wherein information about the objective in question opens in a layer on top of the village view.

The user 1 makes a donation either to the objective already started by clicking the relief objective in question in the village view and thereafter the donate-button of the info-layer, or alternatively to a new objective, which is selected from the building menu.

It is possible for a registered user 1 if he wishes to use additional functions by selecting from the upper menu.

Having selected the donation objective either from the village or from the building menu the user 1 clicks the donate-button in the objective window opening on the screen. If the objective is a building, whether the desire to build a portion or the entire building must be selected. After this, the user 1 selects the form of payment, which are text message, network bank, credit card and other digital forms of payment such as, for example, pre-paid codes. The payment code is a code that an enterprise/community can buy for a desired donation sum and it can be given, for example, to one's customer or partner in cooperation. After this, he who has received the code goes and invests the donation sum tied to the code in some desired virtual village objective, i.e. he selects the objective for a relief donation that has already been made.

After this, the user 1 selects whether he will adopt the objective. Adoption is possible only for a registered user. Adoption may be started by just making a one-time donation of a given sum to an objective. In the event that an adopting contributor or user does not make any donations to the objective in a given time period, the adoption expires and the objective opens once again to donations from other users as well.

Donations can be made to an adopted objective only by an adopting contributor or donor or donor group. In the event that the user 1 adopts an objective, it is possible to challenge other contributors to participate by clicking the “challenge” menu on the screen and entering on the screen the electronic mail addresses of the persons to be challenged or their identification codes. When making a donation there is also always visible on the screen a link “where aid is sent”. The link additionally opens a text window, which tells where collected donations are channelled in the virtual village.

FIG. 3 shows a virtual relief objective according to the invention. More specifically, FIG. 3 shows a graphically implemented virtual relief objective, village view 20, in which the development of the virtual village achieved by the aid given is concretely presented virtually and graphically.

From the graphic virtual village view 20 of the relief objective, the user 1 receives information about the virtual village that is the relief objective and its development. The menus providing this information are village view 20, information about the village 14, function menu 17, news 15, commentators 21 and indicators 22.

The user 1 receives information about the virtual relief objective and its development by clicking the objective he desires in the village view 20, wherein information about the objective in question opens in a layer on top of the village view.

The user 1 makes a donation either to the objective already started by clicking the relief objective in question in the village view 20 and thereafter the donate-button from the info-layer, or alternatively to a new objective, which is selected from the building menu 18. It is possible for a registered user 1 if he wishes to use additional functions by selecting from the function menu 17.

The function menu 17 contains a link back to the world map 12, a register link 10, a log in link 11, an information about the village link 14, a news link 15, a commentator link 21, an indicator link 22, an additional menu for registered users, in the event that the user has logged in, as well as a tell a friend link 19. In the figure, the function menu 17 is shown above and below the virtual village view 20.

In the event that the user 1 has logged in, additional registered user functions may be selected from the function menu, which opens as a layer on top of the village view 20. Additional functions are user information, view donation registry, donor groups, challenges and messages. In user information, it is possible to change user identification and password and to edit user information. Donations made by the user are entered in the donation registry.

In donation groups can be found a list of groups to which the user 1 belongs as well as options for inviting along other registered users or sending an invitation by electronic mail to an unregistered user. In challenges is found a list of the challenges the user 1 has sent and information on whether the challenge was answered as well as additionally instructions for making a challenge using the donation view. In messages can be seen news messages sent to the user 1 about the village to be relieved and the development of the objective. These news messages can also be ordered to the electronic mail of the user 1.

From the function menu 17, the user 1 opens the information about the village window. The window in question opens in a layer on top of the village view 20. The user 1 receives information i.a. about the village, about village history and development, picture and video material of the actual model of the village and information about work done in real life for the benefit of the village. The picture and video material mentioned above can be opened in their own larger view on top of the other content.

From the function menu 17, the user 1 opens news 15. News 15 opens in a layer on top of the village view 20. The news 15 in question is folded in the form of a newspaper and it tells about the development of the village to be relieved. Updating of the news 15 is highly automated and news alternatives are fed to the server 9 in advance, from which the news is retrieved into view in the newspaper according to the development indicated by indicators 22.

From the function menu 17, the user 1 opens commentator 21. Commentator 21 opens in a layer on top of the village view 20. In commentator 21 one actual inhabitant of the village tells about the village, its needs and its development. Commentator 21 is either static, i.e. its content always stays the same, i.e. the village story from the point of view of the commentator, or then it is variable, in which case the commentator 21 tells about development of the village according to indicators such as, for example, “Now the young persons in the village are doing better because the village has a new school” etc.

From the function menu 17, the user 1 opens indicators 22. Indicators 22 follow the development of the village and describe it, for example, on a scale of 4-10. There are four indicators 22: education, health, comfort and development. The outward appearance of indicators 22 is graphic. The value of the indicators 22 is defined in each category by the donated sum (sum of money) as well as by multipliers. If a large amount of money has been donated to education, but the village lacks a school building and money has mostly been donated just for books, the multiplier will be smaller.

The user 1 selects the virtual relief objective and can make a donation either by selecting from the virtual village the objective already started and making a donation to it to help the preparation of the objective or then by selecting from the building menu 18 a new objective and beginning its building by a donation.

In the building menu 18, the virtual donation objectives 13 are arranged in the categories health, education, comfort, development and emergency relief. Objectives 13 are built in layers such that initially available for selection are first level objectives and next level objectives can only be built once the village has been built to the previous stage of development. Virtual donation objectives 13 vary according to the village objective. In general, donation objectives 13 follow the same sort of models and graphically donation objectives 13 are different looking according to the location of the objective. Virtual donation objectives 13 are i.a. a physician, a hospital, a school, a teacher, a water pipe, a well etc.

In addition to the layered building of development objectives, there are in different categories always visible as active also small basic needs objectives, to which a donation may be made at any time. These objectives are i.a. vaccination, medicine, books, containers etc. Additionally, the building menu 18 contains emergency relief objectives, to which donations may be made when the village has, for example, met with a flood or famine, etc.

The building and development of the virtual village is graphically seen in the village/village view 20 also in how the village environment, condition of buildings, etc. appear. As the comfort and development of the village improve as a result of aid, the outward appearance of the village also improves. Along with growth of development, for example, the fields start to look better cared for and the dwellings of the villagers develop to be better looking.

Buildings are built according to when the user 1 makes donations for them. When the amount of donations exceeds a certain limit, the second wall of the building will be built and when the amount exceeds the next limit the third wall is built etc.

When the user 1 clicks the information for a building objective into view, he will be told, for example, in percentage value, how much of the money amount required to finish the next stage of building has been collected.

Beginning a building project takes place from the building menu 18. The user first selects the objective he desires from the alternatives available. Next, the user 1 selects whether he wishes to build the next part of the building or whether he wishes to build the entire objective at once. Next, the user 1 makes a donation of his selected sum. As the donation is made, a link “where aid is sent” is always visible. The link in question opens a text window, which tells where collected donations are channelled in the virtual village.

Once the donation has reached its destination, the user 1 sees in the virtual village the development achieved by the donation. Development is seen as a graphic animation that indicates, for example, a new wall rising in the hospital or the finishing of the school. Once the donation has reached its destination the development achieved has also an effect on indicators 22 and news 15.

From time to time the village may meet with natural disasters or accidents, for example, a flood or famine, wherein the only relief that can be given is emergency relief, as other relief objectives are locked. Catastrophes do not destroy buildings already achieved in the village by donation funds. Catastrophes are linked to reality, i.e. the user 1 can see them virtually on the screen at the same time as they are happening in reality as well.

In a catastrophe situation, emergency relief objectives in the building menu 18 activate and other relief objectives are no longer in use. When enough donations have been given to emergency relief, the other relief objectives will once again become active and the village view will normalize.

When all objectives of the building menu 18 for the village that is the relief objective have been built, the village is finished on the part of building projects. Small donations, such as for vaccinations, schoolbooks and medicine, can still be made. Once village indicators 16 indicate a high degree of development, the village must itself maintain its development level.

The invention is not limited to the embodiments presented, but many variations are possible within the scope of the accompanying claims.

1. A fundraising system comprising:
a user, a teleoperator, an Internet-type network, a database and a data communications network operating between the user and the teleoperator, wherein the arrangement further comprises a fundraising system, that receives donations made by the user to a virtual objective, the fundraising system including:
a server for receiving donations and messages,
means for updating the virtual objective in real time in relation to donations, and
means presenting to the user real-time information relating to the virtual objective.

2. The system of claim 1, further comprising an electronic mail server for receiving and sending electronic mail messages.

3. The system of claim 1, wherein the connection between the user and the server occurs via an electronic mail server.

4. The system of claim 1, further comprising means for registering donations and messages in the server.

5. The system of claim 1, further comprising means for storing received messages in the database.

6. The system of claim 1, further comprising means to deliver and present concretely to the user a graphical virtual picture/village view of the development of the virtual relief objective.

7. The system of claim 1, wherein the database is integrated into the fundraising system.

8. The system of claim 1, wherein the database is integrated into the server.

9. The system of claim 1 wherein the user is in connection with the electronic mail server by electronic mail using a data terminal.

10. The system of claim 1, wherein the user in an Internet-type connection with the server using a data terminal.

11. The system of claim 1, wherein the user is in connection with the server using a mobile data terminal via the data communications network operating between the user and the teleoperator.

12. The system of claim 1, wherein the user defines to the server a manner in which the user wishes to give his donation.

13. The system of claim 12, wherein the user makes a donation by at least one of a text message, a credit card, through a network bank or other digital means of payment.

14. The system of claim 1, wherein the user stores in the database information the user has given about himself.

15. The system of claim 14, wherein the information given by the user includes i.a. name, address, age, telephone number and electronic mail address information.

16. The system of claim 1, wherein the virtual relief objectives selected by the user are villages/cities as well as their related different virtual relief objectives around the world.

17. The system of claim 16, wherein the user adopts the virtual relief objective or virtual donation objective he has selected.

18. The system of claim 1, wherein the user selects whether he wishes to challenge other contributors to participate by clicking the ‘challenge” menu on the screen and entering on the screen the electronic mail addresses or identification codes of the persons to be challenged.

19. The system of claim 1, wherein the information relating to the virtual objective that the server delivers and presents to the user are news about the relief objective, general information about the village, commentator from an inhabitant of the relief objective, development indicators about the relief objective and a graphic virtual village view about development of the relief objective.

20. (canceled)

21. The method of claim 37 further comprising: the user first connecting to a server.

22. The method of claim 21 further comprising: the user registering or logging in to a service on the server.

23. The method of claim 22 further comprising: the user opening in the service a link to the virtual relief objective he desires, wherein further information about the virtual relief objective opens in a village window on the screen.

24. The method of claim 23 further comprising: the user receiving information about the virtual relief objective and related development by clicking the virtual relief objective he desires in a village view.

25. The method of claim 24 further comprising:
the user making a donation either to the virtual relief objective already started by clicking the relief objective from the virtual village view, or to a new virtual relief objective selected from a building menu; and
the user selecting a donate button on an objective window opening on the screen.

26. The method of claim 25 further comprising: the user selecting a manner of donation including at least one of a text message, a network bank, a credit card and other digital means of payment.

27. The method of claim 26 further comprising: the user selecting whether he will adopt the virtual relief objective.

28. The method of claim 27 further comprising: the user selecting whether he wishes to challenge other contributors to participate by clicking a challenge menu on the screen and entering on the screen an electronic mail addresses or identification codes of the contributors being challenged.

29. (canceled)

30. The server of claim 38 wherein the database is integrated into the server.

31. The server of claim 38, wherein the user is in an Internet-type connection with the server using a data terminal.

32. The server of claim 38, wherein the user is in connection with the server using a mobile data terminal via the data communications network.

33. The An server of claim 38 further comprising means for receiving and sending electronic mail messages via an electronic mail server.

34. The server of claim 38 further comprising means for registering donations and messages.

35. The server of claim 38 further comprising means for storing received messages in the database.

36. The server of claim 38 further comprising means for concretely presenting to the user a graphical virtual picture/village view of development of the virtual relief objective.

37. A fundraising method comprising the steps of:
a fundraising system receiving donations made by a user to a virtual objective;
updating the virtual objective in real-time based on the received donations; and
providing real-time information relating to the virtual objective to the user wherein a data communications network operates between the user and a teleoperator over an Internet-type network and the fundraising system includes a database.

38. A server for fundraising, the server comprising:
means for receiving donations and messages intended for a virtual objective;
means for updating the virtual objective in real-time based on the donations; and
means for providing to a user real-time information about the virtual objective, wherein the user communicates with a teleoperator over a data communications network and the server further comprises a database.
